(19) United States
(12) Patent Application Publication
(10) Pub. No.: US 2021/0086548 A1
(43) Pub. Date: Mar. 25, 2021

(54) APPARATUS AND METHOD FOR A LITTY BOARD

(71) Applicant: LazerAim LLC, Nashville, TN (US)

(72) Inventor: Alyse Diane Howard, Nashville, TN (US)

(73) Assignee: LazerAim LLC, Nashville, TN (US)

(21) Appl. No.: 17/029,448

(22) Filed: Sep. 23, 2020

Related U.S. Application Data
(60) Provisional application No. 62/904,041, filed on Sep. 23, 2019.

(51) Int. Cl. B43L 1/00; G06F 3/14

(52) U.S. Cl. CPC B43L 1/008; G06F 3/14

(57) ABSTRACT

A dynamically customizable dry erase board adapted to optimize a user's ability to accomplish objectives, tasks, and visions. The preferred dry erase board comprises a substantially flat surface assembly for removably affixing a plurality of task notes. The preferred substantially flat surface assembly is substantially covered with a graphical design. The preferred dry erase board also comprises a plurality of divider lines that define a plurality of discrete sections on the substantially flat surface assembly. The preferred dry erase board further comprises a plurality of replaceable header label assemblies that are adapted to be removably affixed to the substantially flat surface assembly. In the preferred embodiments of the dry erase board, the plurality of divider lines comprise one or more aesthetically-pleasing colors, and the plurality of replaceable header label assemblies are adapted to be customized by the user.

### CROSS-REFERENCES TO RELATED APPLICATIONS/PATENTS

This application relates back to and claims priority from U.S. Provisional Application for Patent No. 62/904,041 titled Graphic Enhanced Whiteboard with Labeled Divider Sections and dated Sep. 23, 2019.

### FIELD OF THE INVENTION

The preferred embodiments of the present invention generally relate to dynamically customizable tools and supplies. More specifically, the preferred embodiments of the present invention provide a dynamically customizable dry erase board designed to optimize a user's ability to accomplish objectives, tasks, and visions tasks for large-scale and/or multi-faceted projects.

### BACKGROUND AND DESCRIPTION OF THE PRIOR ART

For home and office use, conventional dry erase boards or dry erase boards are associated with tasks and reminders. The general purpose of such conventional boards is “achievement.” Whether the goal is reaching a quarterly sales figure or just to not forget certain grocery items while running errands, conventional dry erase boards and dry erase boards are associated with activities that must be performed in the future. As a result, conventional dry erase boards and dry erase boards are sometimes dreaded to use, can become a symbol of a person's procrastination, and can often be ignored. In addition, conventional dry erase boards are not sufficiently customizable and undesirably limit a user's ability to easily and efficiently organize and rearrange a plurality of tasks.

Dry erase boards can also be an eyesore. Unless someone has handwriting resembling calligraphy, the dry erase boards are normally very messy. In addition, constant erasing and re-writing on the dry erase boards cause “scuff marks” and streaking. Dry erase boards have also been accused of diminishing the aesthetic of rooms they are placed in.

Attempts have been made to adorn dry erase boards with some type of art to make them more attractive. So far, the art has always been a secondary feature of the dry erase board: either as a smaller section of the total width of the board, a hidden covering for the dry erase board after use, or an interchangeable graphic/photo left to the user to choose.

It would be desirable, therefore, if an apparatus and method for a dry erase board could be provided that would encourage a user to use it, minimize or eliminate a user's procrastination, and reduce or eliminate a user's tendency to ignore the board. It would also be desirable if such an apparatus and method or a dry erase board could be provided that would be aesthetically pleasing and less messy, reduce or eliminate “scuff marks” and streaking, and make art a primary feature of the board. It would be further desirable to provide an apparatus and method for a dry erase board that would allow a user to easily, dynamically, and efficiently customize the board and easily, dynamically, and efficiently organize, rearrange, manage, and update the board and the tasks the user places on the board.

### ADVANTAGES OF THE PREFERRED EMBODIMENTS OF THE INVENTION

It is an advantage of the preferred embodiments of the invention described and claimed herein to provide a dynamically customizable dry erase board which prominently incorporates graphic art into the design and function of the board. The preferred embodiments of the dry erase board include graphic art that totally covers the board and is the choice of the manufacturer and/or user. Further, in the preferred embodiments of the dry erase board, each graphic chosen will propel the user toward the pursuit of the planning, research, and execution required to accomplish the user's designated tasks and reduce or eliminate user procrastination and disregard. Still further, in the preferred embodiments of the dry erase board, inspirational imagery is used along with exciting sparkly pops of color on the section divider lines to create what amounts to an aesthetically pleasing work of art by itself.

It is also an advantage of the preferred embodiments of the dry erase board to provide an apparatus and method that engages users as a result of the ability to customize the titles for each section header. In the preferred embodiments of the dry erase board, instead of writing tasks statically and directly on the surface of the board, tasks are written onto sticky notes and placed in the appropriate section. Thus, in the preferred embodiments of the dry erase board, the board and the tasks a user places on the board can be easily, dynamically, and efficiently organized, rearranged, managed, and updated without dirtying the board with undesirable “scuff marks” and streaking. The preferred embodiments of the dry erase board further provide an enjoyable and customizable interactive experience, as well as an attractive and engaging conversation piece.

Additional advantages of the preferred embodiments of the invention will become apparent from an examination of the drawings and the ensuing description.

### EXPLANATION OF THE TECHNICAL TERMS

The use of the terms “a,” “an,” “the,” and similar terms in the context of describing the invention are to be construed to cover both the singular and the plural, unless otherwise indicated herein or clearly contradicted by context. The terms “comprising” “having,” “including,” and “containing” are to be construed as open-ended terms (i.e., meaning “including, but not limited to,”) unless otherwise noted. The terms “substantially,” “generally,” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic. All methods described herein can be performed in any suitable order unless otherwise specified herein or clearly indicated by context.

Terms concerning attachments, coupling and the like, such as “attached,” “connected,” and “interconnected,” refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as,” “preferred,” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

### SUMMARY OF THE INVENTION

The apparatus of the invention comprises a dry erase board adapted to optimize a user's ability to accomplish objectives, tasks, and visions. The preferred dry erase board comprises a substantially flat surface assembly for removably affixing a plurality of task notes. The preferred substantially flat surface assembly is substantially covered with a graphical design. The preferred dry erase board also comprises a plurality of divider lines that define a plurality of discrete sections on the substantially flat surface assembly. The preferred dry erase board further comprises a plurality of replaceable header label assemblies that are adapted to be removably affixed to the substantially flat surface assembly. In the preferred embodiments of the dry erase board, the plurality of divider lines comprise one or more aesthetically-pleasing colors, and the plurality of replaceable header label assemblies are adapted to be customized by the user.

The method of the invention comprises a method for dynamically customizing a dry erase board adapted to optimize a user's ability to accomplish objectives, tasks, and visions. The preferred method comprises providing a dynamically customizable dry erase board. The preferred dynamically customizable dry erase board comprises a substantially flat surface assembly for removably affixing a plurality of task notes. The preferred substantially flat surface assembly is substantially covered with a graphical design. The preferred dynamically customizable dry erase board also comprises a plurality of divider lines that define a plurality of discrete sections on the substantially flat surface assembly. The preferred dynamically customizable dry erase board further comprises a plurality of replaceable header label assemblies that are adapted to be removably affixed to the substantially flat surface assembly. In the preferred embodiments of the dynamically customizable dry erase board, the plurality of divider lines comprise one or more aesthetically-pleasing colors, and the plurality of replaceable header label assemblies are adapted to be customized by the user. The preferred method for dynamically customizing a dry erase board also comprises dynamically customizing the dry erase board.

### BRIEF DESCRIPTION OF THE DRAWINGS

The presently preferred embodiments of the invention are illustrated in the accompanying drawings, in which like reference numerals represent like parts throughout, and in which:

FIG. 1 is a front view of the preferred embodiment of the dry erase board in accordance with the present invention.

FIG. 2 is a perspective view of the preferred embodiment of the dry erase board illustrated by FIG. 1.

FIG. 3 is a front view of the preferred embodiment of the dry erase board illustrated by FIGS. 1 and 2 with a plurality of exemplary notes affixed thereto.

FIG. 4 is a sectional perspective view of the preferred embodiment of the dry erase board illustrated by FIGS. 1-3 taken along line A-A.

FIG. 5 is a front enlarged view of the preferred replaceable header label assembly illustrated by FIGS. 1-4.

FIG. 6 is a sectional end view of preferred dry erase board illustrated by FIGS. 1-5 taken along line B-B.

FIG. 7 is a front view of a first alternative embodiment of the dry erase board in accordance with the present invention.

FIG. 8 is a front view of a second alternative embodiment of the dry erase board in accordance with the present invention.

### DESCRIPTION OF THE PREFERRED EMBODIMENTS OF THE INVENTION

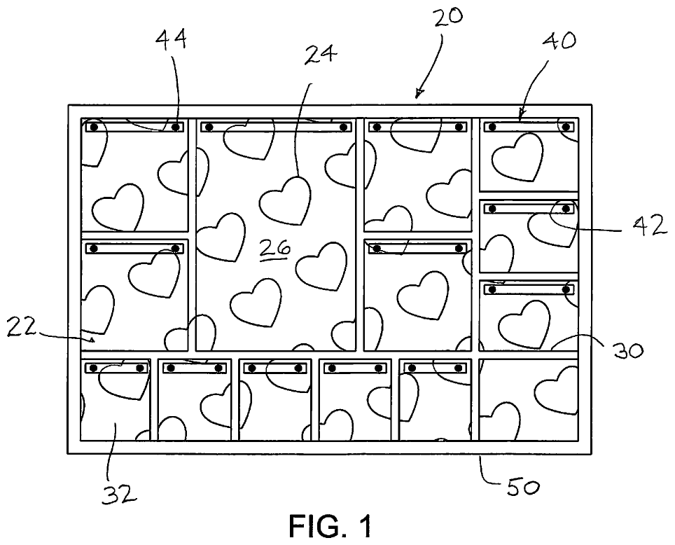

Referring now to the drawings, the preferred embodiment of the dry erase board in accordance with the present invention is illustrated by FIGS. 1 through 8. As shown in FIGS. 1-8, the preferred dry erase board is adapted to optimize a user's ability to accomplish objectives, tasks, and visions generally and comprises a substantially flat surface assembly, a plurality of divider lines, and a plurality of replaceable header label assemblies. The preferred embodiments of the present invention provide a graphic enhanced dry erase board with labeled divider sections. The graphic enhanced dry erase board with labeled divider sections, preferably referred to as the Litty Board, is covered by a design graphic on the front surface and is divided into various sized sections. Each section has a header label, and five of the sections preferably have header labels for the days Monday through Friday. Sticky notes are used to write down tasks or project items. The sticky notes are then organized onto the board under the appropriate section the sticky notes are related to. The sticky notes are then moved to the section for the day that the task will be completed. Once the task is done, that sticky note can be removed from the board.

The preferred embodiments of the present invention provide a graphic enhanced dry erase board with labeled divider sections. In a preferred embodiment, the present invention comprises a board, a graphic vinyl, a plurality of tape strips, a plurality of fastener pieces, a plurality of holding strips, and a plurality of labels. The board of the preferred embodiments present invention serves as the base where the rest of the components are attached to. The graphic vinyl is attached to a surface of the board and serves to provide an ornamental design to the board. The plurality of tape strips is arranged across the board to create a plurality of sections. The plurality of holding strips is designed to hold the plurality of labels on the corresponding

section of the plurality of sections. The plurality of labels helps the users organize tasks and/or items according to categories and a desired scheduling method. The aforementioned components create an engaging, attractive, and efficient dynamically customizable board. The board comprises a board body and a frame. The board body further comprises a first surface and a second surface.

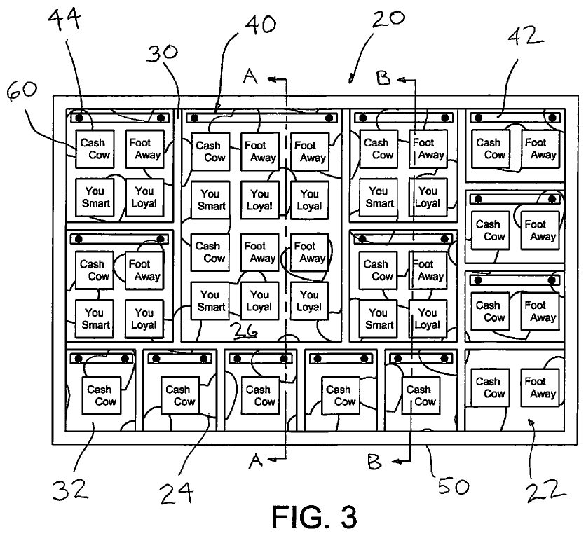

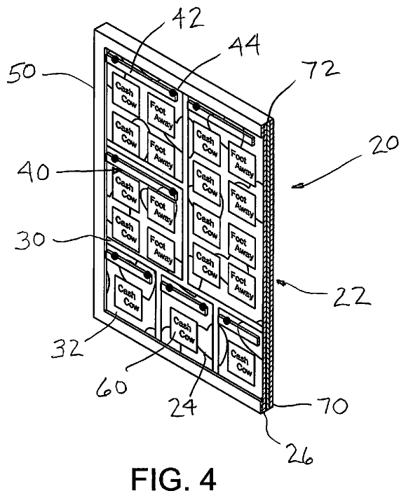

Referring now to FIG. 1, a front view of the preferred embodiment of the dry erase board in accordance with the present invention is illustrated. As shown in FIG. 1, the board body preferably comprises a rectangular, thin design with a size large enough to accommodate the needs of the user. The preferred dry erase board is designated generally by reference numeral 20. Preferred dynamically customizable dry erase board 20 is adapted to optimize a user's ability to accomplish objectives, tasks, and visions. Preferred dry erase board 20 comprises substantially flat surface assembly 22 for removably affixing a plurality of task notes (see, e.g., FIGS. 3 and 4). Preferred substantially flat surface assembly 22 is substantially covered with a graphical design such as plurality of hearts 24. Preferably, substantially flat surface assembly 22 comprises a first layer such as first vinyl layer 26 and a graphical design appears on the first vinyl layer. While the first layer preferably comprises vinyl, it is contemplated within the scope of the invention that the first layer may comprises any suitable material for removably affixing divider lines, header label assemblies and task notes to the dry erase board.

Still referring to FIG. 1, preferred dry erase board also comprises a plurality of divider lines such as tape 30. Preferred tape 30 defines a plurality of discrete sections 32 on substantially flat surface assembly 22. Preferably, tape 30 is adapted to be removably affixed to the first layer of substantially flat surface assembly 22 and comprises one or more aesthetically-pleasing colors. While the preferred divider lines comprise tape, it is contemplated that the divider lines may comprises any suitable material for removably affixing divider lines to the dry erase board.

Still referring to FIG. 1, preferred dry erase board further comprise a plurality of replaceable header label assemblies 40. The preferred plurality of replaceable header label assemblies 40 are adapted to be removably affixed to substantially flat surface assembly 22. Preferably, the plurality of replaceable header label assemblies are adapted to be customized by the user. The preferred plurality of replaceable header label assemblies 40 comprise at least one plastic holding strip 42. The at least one plastic holding strip 42 is hollow and clear and removably affixed to substantially flat surface assembly 22 via a plurality of hook-and-loop fasteners 44. Preferably, the plurality of hook-and-loop fasteners 44 are disposed near a top portion of each of the plurality of discrete sections 32 and on each of the plurality of replaceable header label assemblies 40. While FIG. 1 illustrates hook-and-loop fasteners, it is contemplated within the scope of the invention that any suitable means for removably attaching the replaceable header label assemblies may be used such as magnets, metal, tape, adhesives, and the like.

Still referring to FIG. 1, preferred dry erase board 20 comprises frame 50. Preferred frame 50 substantially surrounds substantially flat surface assembly 22.

While FIG. 1 illustrates the preferred configuration and arrangement of the dry erase board in accordance with the present invention, it is contemplated within the scope of the invention that that dry erase board may be of any suitable configuration and arrangement. It is also contemplated within the scope of the invention that the dry erase board may be in a digital format.

Still referring to FIG. 1, in the preferred embodiments of the present invention, the graph vinyl comprises a design graphic to help decorate the board. As can be seen in FIG. 1, the graphic vinyl preferably comprises a vinyl body, a first vinyl face, a second vinyl face, and adhesive. As can be seen in FIG. 1, the vinyl body comprises a shape and size matching the shape and size of the first surface of the board body. The first vinyl face is provided opposite the second vinyl face about the vinyl body. As can be seen in FIG. 1, the first vinyl face can comprise a plurality of graphics, a plurality of indicia, or other items corresponding to a graphic design. The adhesive is provided on the second vinyl face to facilitate the attachment of the graphic vinyl to the board. In alternate embodiments, the graphic vinyl can be replaced with a graphic printed on the first surface of the board body.

Still referring to FIG. 1, in the preferred embodiments, the first vinyl face on the board is divided into a plurality of sections utilizing a plurality of tape strips. As can be seen in FIG. 1, the plurality of tapes strips comprises multiple tape strips of multiple lengths arranged to form rectangular divisions of the first vinyl face. In the preferred embodiment, the plurality of tape strips corresponds to strips of Washi tape. In alternate embodiments of the present invention, the plurality of tape strips can be replaced with strips of different materials or integrated into the design of the graphic vinyl.

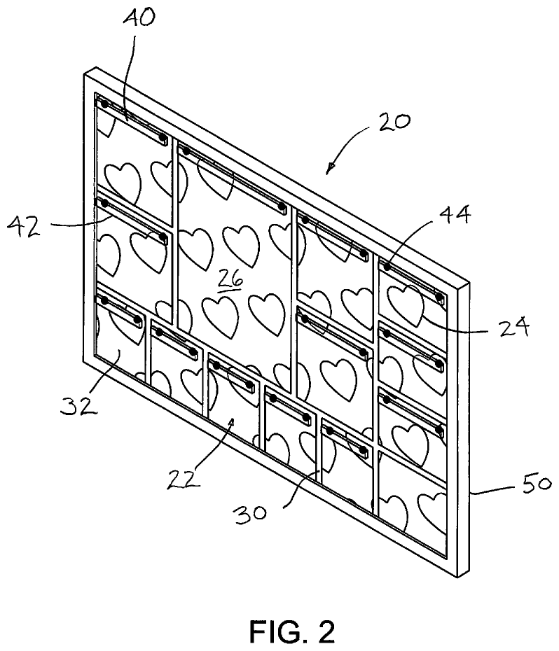

Referring now to FIG. 2, a perspective view of preferred dry erase board 20 is illustrated. As shown in FIG. 2, preferred dry erase board 20 comprises substantially flat surface assembly 22, a plurality of graphic images such as hearts 24, first vinyl layer 26, a tape 30, a plurality of sections 32, a plurality of replaceable header label assemblies 40, at least one plastic holding strip 42, a plurality of hook-and-loop fasteners 44, and frame 50.

Referring now to FIG. 3, a front view of preferred dry erase board 20 is illustrated with a plurality of exemplary task notes affixed thereto. As shown in FIG. 3, preferred dry erase board 20 comprises substantially flat surface assembly 22, a plurality of graphic images such as hearts 24, first vinyl layer 26, a tape 30, a plurality of sections 32, a plurality of replaceable header label assemblies 40, at least one plastic holding strip 42, a plurality of hook-and-loop fasteners 44, and frame 50. Preferred dry erase board also comprises a plurality of task notes 60. Preferred task notes 60 are adapted to be removably affixed to the first layer of preferred substantially flat surface assembly 22.

Still referring to FIG. 3, a plurality of notes can be further provided with the preferred embodiments of the present invention. The plurality of notes preferably correspond to a plurality of sticky notes. The plurality of sticky notes can include sticky notes of various shapes and designs which can be arranged within each section of the plurality of sections. As can be seen in FIGS. 2-3, users can write on the plurality of sticky notes and attach one or more notes of the plurality of sticky notes to the corresponding section of the plurality of sections. In alternate embodiments of the present invention, the users can utilize different tools to record information which can be removably attached to the first surface of the board.

Referring now to FIG. 4, a sectional perspective view of the preferred dry erase board 20 is illustrated taken along line A-A shown in FIG. 3. As shown in FIG. 4, preferred dry erase board 20 comprises substantially flat surface assembly 22, a plurality of graphic images such as hearts 24, first vinyl layer 26, tape 30, a plurality of sections 32, a plurality of replaceable header label assemblies 40, plastic holding strip 42, a plurality of hook-and-loop fasteners 44, frame 50, and task notes 60. In addition, preferred dry erase board 20 comprises second layer 70 and base 72. Preferred second layer 70 comprises vinyl and preferred base 72 comprises a magnetic material. Preferably, the first vinyl layer is affixed to a first side of base 72 and the second vinyl layer is affixed to a second side of the base.

Still referring to FIG. 4, the first surface is preferably provided opposite the second surface about the board body. The frame comprises a shaped and size matching the shape and size of the board body. As can be seen in FIG. 4, the preferred frame is perimetrically attached to the board body, leaving the first surface and the second surface accessible to the user. In the preferred embodiments of the present invention, the board body is made from magnetic material which enables magnetic items to be attached to the first surfaces and/or the second surface. In alternate embodiments, the board body may comprise non-rectangular designs made from different materials.

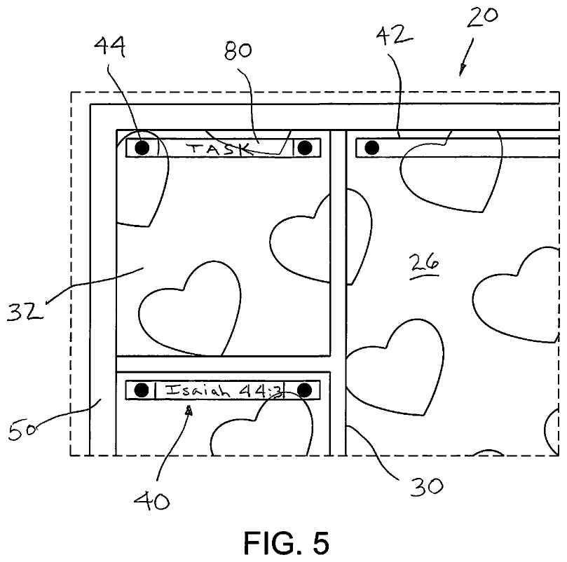

Referring now to FIG. 5, an enlarged front view of preferred dry erase board 20 is illustrated. As shown in FIG. 5, preferred dry erase board 20 comprises first vinyl layer 26, tape 30, a plurality of sections 32, a plurality of replaceable header label assemblies 40, plastic holding strips 42, hook-and-loop fasteners 44, frame 50, and label inserts 80. The preferred at least one label inserts 80 is adapted to be removably inserted into at least one of the plurality of replaceable header label assemblies 40 and is clear. While the preferred replaceable header label assembly comprises at least one hook and loop fastener, it is also contemplated within the scope of the invention that the replaceable header label assembly may comprise one or more metal tabs or strips, double-sided tape, or any other suitable material that allows the replaceable header label assemblies to be removably affixed to the dry erase board.

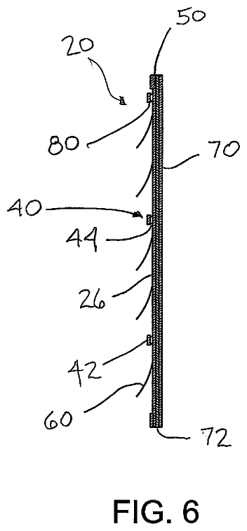

Referring now to FIG. 6, a sectional view of the preferred replaceable header label assembly taken along line B-B is illustrated. As shown in FIG. 6, preferred dry erase board 20 comprises first vinyl layer 26, replaceable header label assemblies, 40, plastic holding strip 42, hook-and-loop fastener 44, frame 50, notes 60, second layer 70, base 72 label inserts 80.

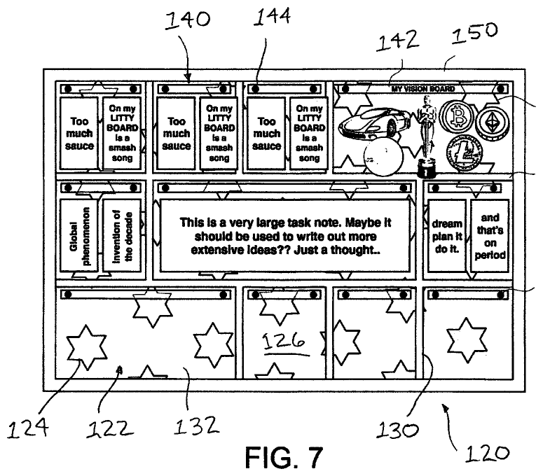

Referring now to FIG. 7, a front view of a first alternative embodiment of the dry erase board in accordance with the present invention is illustrated. As shown in FIG. 7, the first alternative embodiment of the dry erase board is designated generally by reference numeral 120. Preferred dry erase board 120 comprises substantially flat surface assembly 122, a plurality of graphic images such as stars 124, first vinyl layer 126, tape 130, a plurality of sections 132, a plurality of replaceable header label assemblies 140, at least one plastic holding strip 142, a plurality of hook-and-loop fasteners 144, and frame 150.

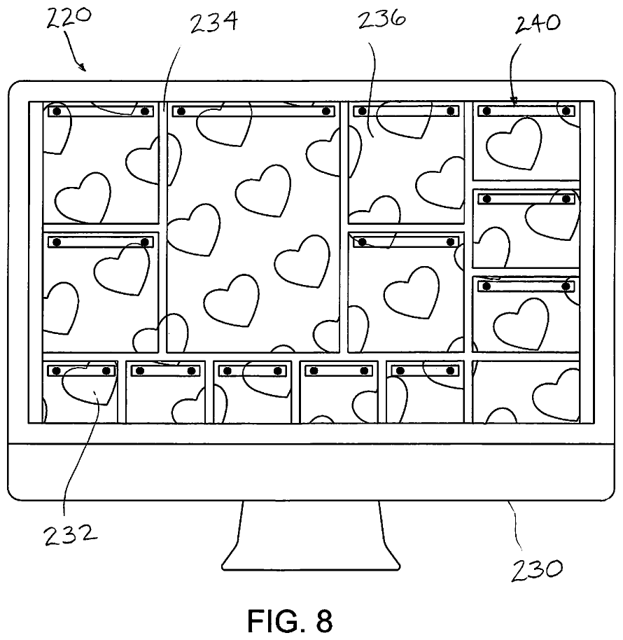

Referring now to FIG. 8, a front view of a second alternative embodiment of the dry erase board in accordance with the present invention is illustrated. As shown in FIG. 8, the preferred embodiment of the dry erase board is designated generally by reference numeral 220. Preferred dry erase board 220 is in a digital format. More particularly, preferred dry erase board 220 is displayed in digital format on desktop terminal 230. It is also contemplated within the scope of the invention that preferred dry erase board 220 may be displayed on a computer monitor, a laptop screen, a tablet screen, a mobile device screen, and the like. As shown in FIG. 8, preferred dry erase board 220 comprises a plurality of graphic images such as hearts 232, dividing lines 234, a plurality of sections 236, a plurality of header labels 240. Preferred dividing lines 234 may be moved by the user to produce different arrays of sections. Preferred header labels 240 may be customized with text or other graphic images. Notes in digital format may be created in one or more of the plurality of sections 236.

The preferred embodiments of the present invention provide a method for dynamically customizing a dry erase board adapted to optimize a user's ability to accomplish objectives, tasks, and visions. The preferred method comprises providing a dynamically customizable dry erase board. The preferred dynamically customizable dry erase board comprises a substantially flat surface assembly for removably affixing a plurality of task notes. The preferred substantially flat surface assembly is substantially covered with a graphical design. The preferred dynamically customizable dry erase board also comprises a plurality of divider lines that define a plurality of discrete sections on the substantially flat surface assembly. The preferred dynamically customizable dry erase board further comprises a plurality of replaceable header label assemblies that are adapted to be removably affixed to the substantially flat surface assembly. In the preferred embodiments of the dynamically customizable dry erase board, the plurality of divider lines comprise one or more aesthetically-pleasing colors, and the plurality of replaceable header label assemblies are adapted to be customized by the user. The preferred method for dynamically customizing a dry erase board also comprises dynamically customizing the dry erase board.

In other preferred embodiments of the method for dynamically customizing a dry erase board, the method also provides at least one label adapted to be customized. In addition, the preferred methods of the present invention enable users to obtain label replacements. The method can include, but is not limited to, software applications which facilitate the automated replacement or customization of labels. In alternate embodiments of the present invention, the dry erase board can provide different methods of label customization or replacement.

In operation, several advantages of the preferred embodiments of the invention are achieved. For example, the preferred embodiments of the dry erase board prominently incorporate graphic art into the design and function of the board. The preferred embodiments of the dry erase board include graphic art that totally covers the board and is the choice of the manufacturer and/or user. Further, in the preferred embodiments of the dry erase board, each graphic chosen will propel the user toward the pursuit of the planning, research, and execution required to accomplish the user's designated tasks and reduce or eliminate user procrastination and disregard. Still further, in the preferred embodiments of the dry erase board, inspirational imagery is used along with exciting sparkly pops of color on the section divider lines to create what amounts to an aesthetically pleasing work of art by itself.

In addition, the preferred embodiments of the dry erase board engage users as a result of the ability to customize the titles for each section header. With the preferred embodiments of the dry erase board, instead of writing tasks statically and directly on the surface of the board, tasks are written onto sticky notes and placed in the appropriate section. Thus, in the preferred embodiments of the dry erase board, the board and the tasks a user places on the board can be easily, dynamically, and efficiently organized, rearranged, managed, and updated without dirtying the board with undesirable “scuff marks” and streaking. The preferred embodiments of the dry erase board further provide an enjoyable and customizable interactive experience, as well as an attractive and engaging conversation piece.

In the preferred embodiments of the present invention, the adhesive graphic vinyl is first applied to the front surface of the board. Multiple strips of tape, preferably Washi tape, are then used to divide the board front surface into multiple sections. Hook and loop fastener dots are used to attach a hollow plastic strip to each section, thus creating a header label. The name of the section is preferably printed onto a clear label and applied to each header label.

As can be seen in the drawings, the first vinyl face is divided into a plurality of sections of various sizes according to the users requirements. In the preferred, the plurality of sections comprises a first set of sections, a second set of sections, a third set of sections, one or more center sections, and one or more corner sections. Preferably, the first set of sections correspond to five sections provided adjacent to the lower edge of the board. The five sections of the first set of sections are distributed from the first lower corner up to a distance from the second lower corner. As can be seen in drawings the remaining space is delegated to the one or more corner sections which comprise a length longer than the length of the five sections of the first set of sections. As can be seen in the drawings, the second set of sections is vertically arranged on top of the one or more corner sections and preferably comprises three rectangular sections. As can be seen in the drawings, the third set of sections are distributed about the remaining space between the first set of the sections and the second set of sections. Further, the one or more center sections are centrally positioned within the third set of sections. As can be seen in the drawings, the third set of sections preferably comprises four sections and the one or more center sections comprise one section. In addition, the one or more center sections comprise a length and height larger than the length and height of the sections of the third set of sections. In alternate embodiments, the plurality of sections can be arranged into different arrangements with individual or set of sections of different shapes and sizes.

As can be seen in the drawings, the plurality of fastener pieces is distributed about the plurality of sections to facilitate the attachment of the plurality of holding strips to the first vinyl face. In the preferred embodiment, the plurality of fastener pieces is a plurality of hook and loop fastener dots provided on the first vinyl face and on the rear of the plurality of holding strips. Further, the plurality of holding strips is a plurality of hollow transparent plastic strips. As can be seen in the drawings, at least two hook and loop fastener dots are arranged near the top edge of each of the plurality of sections. Likewise, at least two matching hook and loop fasteners dots are arranged on the back of each holding strip. Thus, at least one holding strip of the plurality of holding strips is attached on each of the plurality of sections, preferably centered adjacent to the top edge of each section. In alternate embodiments of the present invention, the plurality of fastener pieces can be replaced with other appropriate fasteners and the plurality of holding strips can be made from alternate materials. In the preferred embodiments of the present invention, the plurality of labels can be customized to meet the users' requirements. Each of the labels of the plurality of labels comprise a shape and a size matching the corresponding holding strip of the plurality of holding strips.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims. All illustrations of the drawings are for the purpose of describing selected versions of the present invention and are not intended to limit the scope of the present invention. Although the invention has been explained in relation to its preferred embodiments, it is to be understood that many other possible modifications and variations can be made without departing from the spirit and scope of the invention.

What is claimed is:

1. A dynamically customizable dry erase board adapted to optimize a user's ability to accomplish objectives, tasks, and visions, said dry erase board comprising:
a. a substantially flat surface assembly for removably affixing a plurality of task notes, said substantially flat surface assembly being substantially covered with a graphical design;
b. a plurality of divider lines, said plurality of divider lines defining a plurality of discrete sections on the substantially flat surface assembly;
c. a plurality of replaceable header label assemblies, said plurality of replaceable header label assemblies being adapted to be removably affixed to the substantially flat surface assembly;
wherein the plurality of divider lines comprise one or more aesthetically-pleasing colors;
and wherein the plurality of replaceable header label assemblies are adapted to be customized by the user.

2. The dry erase board of claim 1 wherein the substantially flat surface assembly comprises a first vinyl layer.

3. The dry erase board of claim 2 wherein the substantially flat surface assembly comprises a second vinyl layer.

4. The dry erase board of claim 3 wherein the substantially flat surface assembly comprises a base.

5. The dry erase board of claim 4 wherein the base comprises a magnetic material.

6. The dry erase board of claim 4 wherein the first vinyl layer is affixed to a first side of the base and the second vinyl layer is affixed to a second side of the base.

7. The dry erase board of claim 1 wherein the plurality of divider lines comprises tape.

8. The dry erase board of claim 7 wherein the tape is adapted to be removably affixed to the substantially flat surface assembly.

9. The dry erase board of claim 1 wherein the plurality of replaceable header label assemblies comprises at least one plastic holding strip.

10. The dry erase board of claim 9 wherein the at least one plastic holding strip is hollow.

11. The dry erase board of claim 9 wherein the at least one plastic holding strip is clear.

12. The dry erase board of claim 1 wherein the plurality of replaceable header label assemblies are removably affixed to the substantially flat surface assembly via a plurality of hook-and-loop fasteners.

13. The dry erase board of claim 12 wherein the plurality of hook-and-loop fasteners are disposed near a top portion of each of the plurality of discrete sections and on each of the plurality of replaceable header label assemblies.

14. The dry erase board of claim 1 wherein the plurality of replaceable header label assemblies comprises at least one label insert.

15. The dry erase board of claim 14 wherein the at least one label insert is adapted to be removably inserted into at least one of the plurality of replaceable header label assemblies.

16. The dry erase board of claim 14 wherein the at least one label insert is clear.

17. The dry erase board of claim 1 further comprising a frame.

18. The dry erase board of claim 17 wherein the frame substantially surrounds the substantially flat surface assembly.

19. The dry erase board of claim 1 wherein the board is in a digital format.

20. A method for dynamically customizing a dry erase board adapted to optimize a user's ability to accomplish objectives, tasks, and visions, said method comprising:
a. providing a dynamically customizable dry erase board, said dynamically customizable dry erase board comprising:
(i) a substantially flat surface assembly for removably affixing a plurality of task notes, said substantially flat surface assembly being substantially covered with a graphical design;
(ii) a plurality of divider lines, said plurality of divider lines defining a plurality of discrete sections on the substantially flat surface assembly;
(iii) a plurality of replaceable header label assemblies, said plurality of replaceable header label assemblies being adapted to be removably affixed to the substantially flat surface assembly;
wherein the plurality of divider lines comprise one or more aesthetically-pleasing colors; and wherein the plurality of replaceable header label assemblies are adapted to be customized by the user; and,
b. dynamically customizing the dry erase board.
